(19) United States
(12) Patent Application Publication
(10) Pub. No.: US 2010/0021678 A1
(43) Pub. Date: Jan. 28, 2010

(54) Thermal conduction principle and device for intercrossed structure having different thermal characteristics

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/232,278

(22) Filed: Sep. 15, 2008

Related U.S. Application Data
(63) Continuation-in-part of application No. 12/219,475, filed on Jul. 23, 2008.

(51) Int. Cl. B32B 3/00; B32B 7/02; B32B 3/06

(52) U.S. Cl. 428/77; 428/212; 428/102

(57) ABSTRACT

The present invention discloses that the relay thermal conductor being made of material having better thermal conductivity coefficient is thermal conductively coupled with the heating or cooling first thermal body at one end or face thereof, and is coupled with interface thermal conductor having higher specific heat capacity at the other end or face thereof, wherein the relay thermal conductor directly performs thermal conduction with second thermal body at another part thereof and the interface thermal conductor having higher specific heat capacity is the thermal conducting carrier between relay thermal conductor and second thermal body.

### CROSS-REFERENCE TO RELATED APPLICATION

This application is a Continuation-In-Part of U.S. patent application Ser. No. 12/219,475, filed Jul. 23, 2008.

### BACKGROUND OF THE INVENTION

(a) Field of the Invention

The present invention discloses that at least two layers of thermal energy conducting structures in particular intercrossed overlapping layers embodiment are commonly constituted by at least two thermal energy conductive material having at least one of different thermal conductivity coefficient, specific heat capacity, or thermal emissivity, thereby promoting the thermal conducting effect.

(b) Description of the Prior Art

The cooling or heating source of the first thermal body of the conventional thermal conducting structure constituted by a single material is usually limited by the smaller thermally conducting area of the thermal conducting device, such as that if the heat source of first thermal body is the thermal energy of the heat loss in CPU of computer, or power semiconductor, or light emitting diode (LED), except for heat pipe or other cooling or heating device of the like having full area contact in the enclosed space, then if it is coupled with said thermal bodies for heat dissipating operation, if the thermal conducting structure is made of single material, and even if the thermal conductivity coefficient of the single material is better, its specific heat capacity is usually not the best, such as that if the heat dissipator of CPU, power semiconductor, or light emitting diodes being made of copper material is heavier and expensive, and although it has a better thermal conductivity coefficient and its specific heat capacity is lower than aluminum;

If single material of better specific heat capacity with lighter weight and lower price is adopted, such as the heat dissipator of CPU, power semiconductor or light emitting diode being made of aluminum, though it has a higher specific heat capacity and thermal emissivity, its thermal conductivity coefficient is lower than that of copper material, therefore the thermal conducting effect for thermal conducting structure made of single material is more limited.

### SUMMARY OF THE INVENTION

The present invention innovatively discloses a thermal conduction principle and device for intercrossed structure having different thermal characteristics, wherein the thermal conducting structure of the particular intercrossed overlapping layer construction is made of materials with different thermal conducting characteristics and is different from the conventional thermal conducting device being made of single material, wherein the relay thermal conductor of the thermal conduction principle and device for intercrossed structure having different thermal characteristics of the present invention being made of material with better thermal conductivity coefficient is thermal conductively coupled with the heating or cooling first thermal body at one end or surface thereof, and is coupled with interface thermal conductor at the other end or face thereof, and the other portion is for directly thermal conduct with the second thermal body, wherein said interface thermal conductor having the thermal conducting characteristics with all or at least one of the 1) higher specific heat capacity relative to relay thermal conductor, or 2) a better thermal conductivity coefficient to second thermal body relative to relay thermal conductor, or 3) a better thermal emissivity to second thermal body relative to relay thermal conductor being good is used as the thermal conducting carrier between the relay thermal conductor and the second thermal body; and is favorable for thermal energy conduction by the particular intercrossed overlapping layer construction having different thermal characteristics when there is temperature difference between the first thermal body and the second thermal body.

### BRIEF DESCRIPTION OF THE DRAWINGS

FIG. 1 is a schematic view of the three-layer type layer by layer overlapping structure principle of prior art.

FIG. 2 is a schematic view of the structure principle showing that the thermal conductive interlayer (110) is additionally installed between the interface thermal conductor (103) and the relay thermal conductor (102) in FIG. 1 of prior art.

FIG. 3 is a schematic view showing that the multi-layered structure of the present invention is partially cross-layered combined to be thermal conductive composing structure.

FIG. 4 is the first schematic view showing that the multi-layered structure of the present invention is partially cross-layered combined to be thermal conductive composing structure.

FIG. 5 is the second schematic view showing that the multi-layered structure of the present invention is partially cross-layered combined to be thermal conductive composing structure.

FIG. 6 is the third schematic view showing that the multi-layered structure of the present invention is partially cross-layered combined to be thermal conductive composing structure.

FIG. 7 is the fourth schematic view showing that the multi-layered structure of the present invention is partially cross-layered combined to be thermal conductive composing structure.

FIG. 8 is the fifth schematic view showing that the multi-layered structure of the present invention is partially cross-layered combined to be thermal conductive composing structure.

FIG. 9 is the sixth schematic view showing that the multi-layered structure of the present invention is partially cross-layered combined to be thermal conductive composing structure.

### DESCRIPTION OF MAIN COMPONENT SYMBOLS

101: First thermal body
102: Relay thermal conductor
103: Interface thermal conductor
104: Second thermal body
110: Thermal conductive interlayer

### DETAILED DESCRIPTION OF THE PREFERRED EMBODIMENTS

The present invention innovatively discloses a thermal conduction principle and device for intercrossed structure having different thermal characteristics, wherein the thermal conducting structure of the particular intercrossed overlapping layer construction is made of materials with different thermal conducting characteristics and is different from the conventional thermal conducting device being made of single material, wherein the relay thermal conductor of the thermal conduction principle and device for intercrossed structure having different thermal characteristics of the present invention being made of material with better thermal conductivity coefficient is thermal conductively coupled with the heating or cooling first thermal body at one end or surface thereof, and is coupled with interface thermal conductor at the other end or surface thereof, wherein the relay thermal conductor directly perform thermal conduction with the second thermal body at another part thereof, wherein said interface thermal conductor having the thermal conducting characteristics with all or at least one of the 1) higher specific heat capacity relative to relay thermal conductor, or 2) a better thermal conductivity coefficient to second thermal body relative to relay thermal conductor, or 3) a better thermal emissivity to second thermal body relative to relay thermal conductor being good is used as the thermal conducting carrier between the relay thermal conductor and the second thermal body; and is favorable for thermal energy conduction by the particular intercrossed overlapping layer construction having different thermal characteristics when there is temperature difference between the first thermal body and the second thermal body.

For the thermal conduction principle and device for intercrossed structure having different thermal characteristics, beside of aforesaid layer by layer overlapping multi-layered structure, the multi-layered structure can be partially cross-layered combined under this basis to be the composing structure for thermal transfer to further promote the thermal transfer function; wherein it is described in the following:

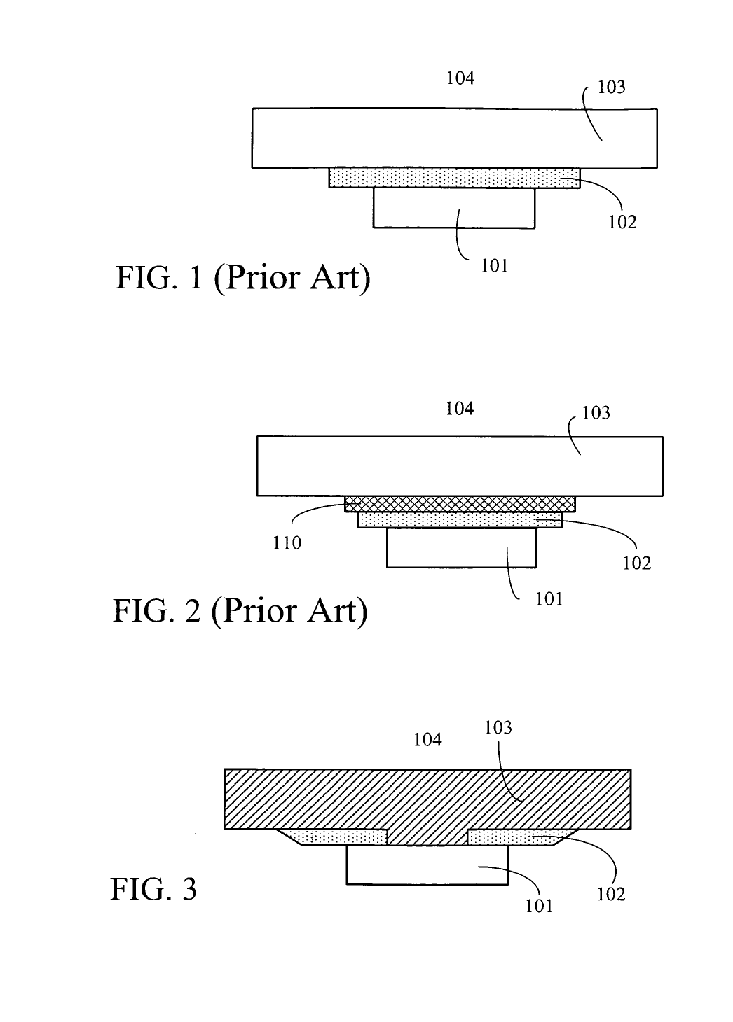

FIG. 1 is a schematic view of the three-layer type layer by layer overlapping structure principle of prior art.

FIG. 2 is a schematic view of the structure principle showing that the thermal conductive interlayer (110) is additionally installed between the interface thermal conductor (103) and the relay thermal conductor (102) in FIG. 1 of prior art.

Aforementioned FIG. 1 and FIG. 2 are the basic concept of the layer by layer overlapping multi-layer structure; As shown in FIG. 1, the heat source of the first thermal body (101) is the thermal energy of heat loss in CPU of the computer, or power semiconductor, or light emitting diode (LED) which is not directly combined with the interface thermal conductor (103); as shown in FIG. 2, the heat source of the first thermal body (101) is the thermal energy of heat loss in CPU of the computer, or power semiconductor, or light emitting diode (LED) which is not directly combined with the thermal conductive interlayer (110) or the interface thermal conductor (103), and the relay thermal conductor (102) and the interface thermal conductor (103) also are not directly combined; hence, based on application requirements as well as manufacture and space considerations, the structure can be further promoted by partially cross-layered combining the multi-layered structure to be the composing structure for thermal transfer, i.e under the basis of FIG. 1, the thermal conducting surface of first thermal body (101) is not only combined with the relay thermal conductor (102), but also partially combined with the interface thermal conductor (103), wherein the position of thermal conducting surfaces of the first thermal body (101) for combining with relay thermal conductor (102) and interface thermal conductor (103) can be selected according to thermal flow distribution of temperature difference and application conditions.

FIG. 3 is a schematic view showing that the multi-layered structure of the present invention is partially cross-layered combined to be thermal conductive composing structure.

Structure characteristics of cross layer combination as shown in FIG. 3 are the following:

The thermal conducting surface of first thermal body (101) is partially combined with relay thermal conductor (102), and partially combined with interface thermal conductor (103);

The thermal conducting surface of relay thermal conductor (102) is partially combined with first thermal body (101), and partially combined with interface thermal conductor (103);

The thermal conducting surface of interface thermal conductor (103) is partially coupled with second thermal body (104);

The conductive area, thickness and thermal characteristics of thermal conductive material of each cross-layer combined surface and original multi-layer combined surface can be selected according to thermal flow distribution of temperature difference and application conditions;

The first thermal body (101) can be the heat source or heat absorbing body;

The second thermal body (104) can be the heat source or heat absorbing body.

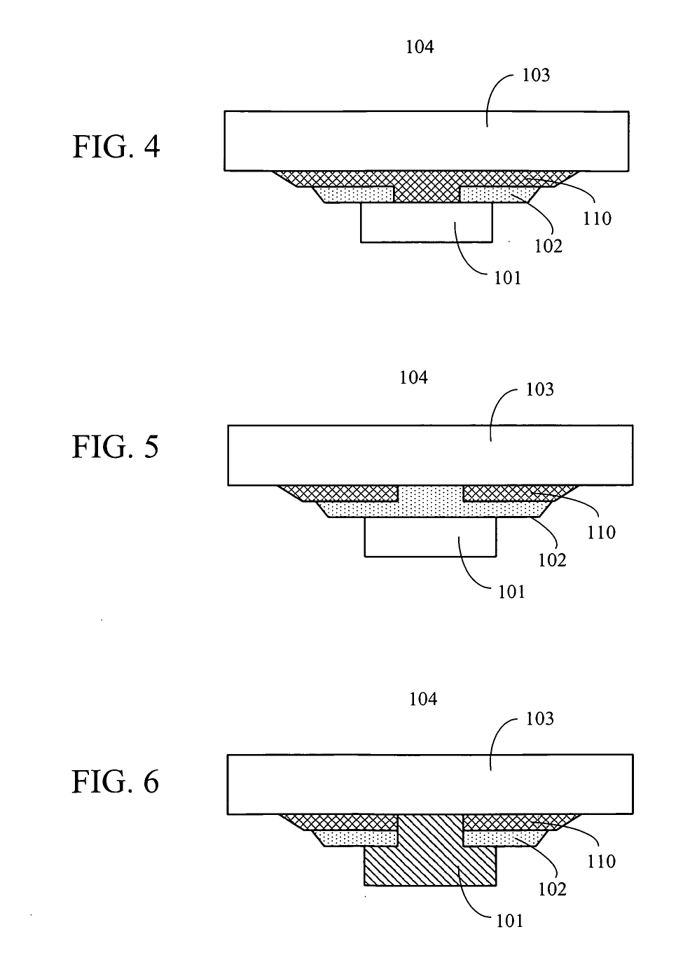

FIG. 4 is the first schematic view showing that the multi-layered structure of the present invention is partially cross-layered combined to be thermal conductive composing structure.

Structure characteristics of cross layer combination as shown in FIG. 4 are the following:

The thermal conducting surface of first thermal body (101) is partially combined with relay thermal conductor (102), and partially combined with thermal conductive interlayer (110);

The thermal conducting surface of relay thermal conductor (102) is partially combined with first thermal body (101), and partially combined with thermal conductive interlayer (110);

The thermal conducting surface of thermal conductive interlayer (110) is partially combined with interface thermal conductor (103), partially combined with relay thermal conductor (102), and partially combined with first thermal body (101);

The thermal conducting surface of interface thermal conductor (103) is partially combined with thermal conductive interlayer (110), and partially coupled with second thermal body (104);

The conductive area, thickness and thermal characteristics of thermal conductive material of each cross-layer combined surface and original multi-layer combined surface can be selected according to thermal flow distribution of temperature difference and application conditions;

The first thermal body (101) can be the heat source or heat absorbing body;

The second thermal body (104) can be the heat source or heat absorbing body.

FIG. 5 is the second schematic view showing that the multi-layered structure of the present invention is partially cross-layered combined to be thermal conductive composing structure.

Structure characteristics of cross layer combination as shown in FIG. 5 are the following:

The thermal conducting surface of first thermal body (101) is combined with relay thermal conductor (102);

The thermal conducting surface of relay thermal conductor (102) is partially combined with first thermal body (101), partially combined with thermal conductive interlayer (110), and partially combined with interface thermal conductor (103);

The thermal conducting surface of thermal conductive interlayer (110) is partially combined with interface thermal conductor (103), and partially combined with relay thermal conductor (102);

The thermal conducting surface of interface thermal conductor (103) is partially combined with thermal conductive interlayer (110), partially combined with relay thermal conductor (102), and partially coupled with second thermal body (104);

The conductive area, thickness and thermal characteristics of thermal conductive material of each cross-layer combined surface and original multi-layer combined surface can be selected according to thermal flow distribution of temperature difference and application conditions;

The first thermal body (101) can be the heat source or heat absorbing body;

The second thermal body (104) can be the heat source or heat absorbing body.

FIG. 6 is the third schematic view showing that the multi-layered structure of the present invention is partially cross-layered combined to be thermal conductive composing structure.

Structure characteristics of cross layer combination as shown in FIG. 6 are the following:

The thermal conducting surface of first thermal body (101) is partially combined with relay thermal conductor (102), partially combined with thermal conductive interlayer (110), and partially combined with interface thermal conductor (103);

The thermal conducting surface of relay thermal conductor (102) is partially combined with first thermal body (101), and partially combined with thermal conductive interlayer (110);

The thermal conducting surface of thermal conductive interlayer (110) is partially combined with interface thermal conductor (103), partially combined with relay thermal conductor (102), and partially combined with first thermal body (101);

The thermal conducting surface of interface thermal conductor (103) is partially combined with thermal conductive interlayer (110), partially combined with first thermal body (101), and partially coupled with second thermal body (104);

The conductive area, thickness and thermal characteristics of thermal conductive material of each cross-layer combined surface and original multi-layer combined surface can be selected according to thermal flow distribution of temperature difference and application conditions;

The first thermal body (101) can be the heat source or heat absorbing body;

The second thermal body (104) can be the heat source or heat absorbing body.

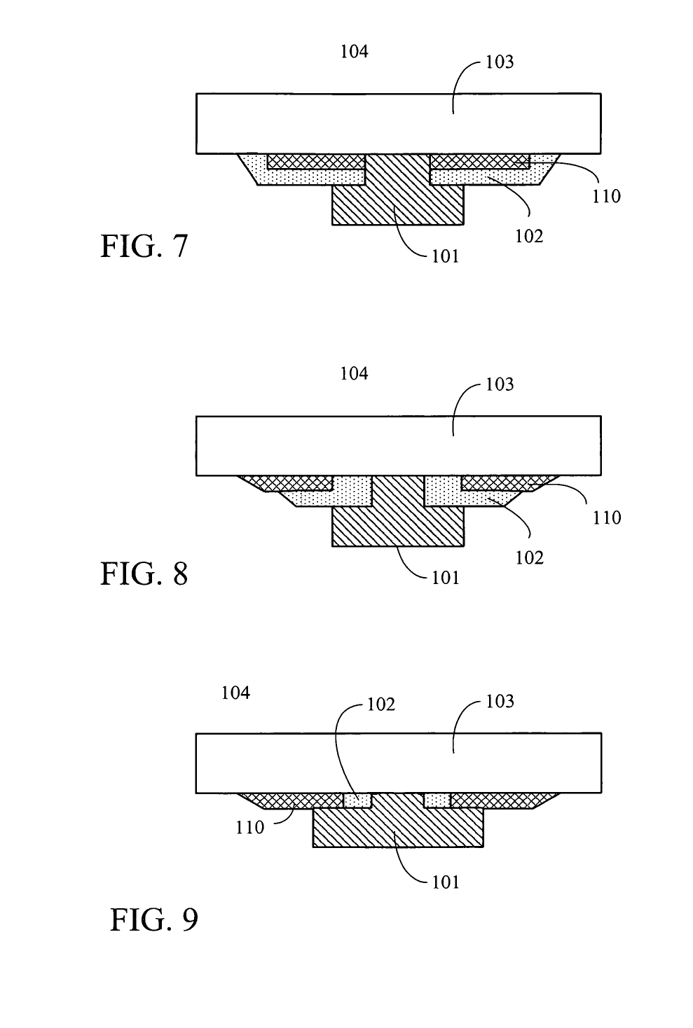

FIG. 7 is the fourth schematic view showing that the multi-layered structure of the present invention is partially cross-layered combined to be thermal conductive composing structure.

Structure characteristics of cross layer combination as shown in FIG. 7 are the following:

The thermal conducting surface of first thermal body (101) is partially combined with relay thermal conductor (102), partially combined with thermal conductive interlayer (110), and partially combined with interface thermal conductor (103);

The thermal conducting surface of relay thermal conductor (102) is partially combined with first thermal body (101), partially combined with thermal conductive interlayer (110), and partially combined with interface thermal conductor (103);

The thermal conducting surface of thermal conductive interlayer (110) is partially combined with first thermal body (101), partially combined with relay thermal conductor (102), and partially combined with interface thermal conductor (103);

The thermal conducting surface of interface thermal conductor (103) is partially combined with first thermal body (101), partially combined with relay thermal conductor (102), partially combined with thermal conductive interlayer (110), and partially coupled with second thermal body (104);

The conductive area, thickness and thermal characteristics of thermal conductive material of each cross-layer combined surface and original multi-layer combined surface can be selected according to thermal flow distribution of temperature difference and application conditions;

The first thermal body (101) can be the heat source or heat absorbing body;

The second thermal body (104) can be the heat source or heat absorbing body.

FIG. 8 is the fifth schematic view showing that the multi-layered structure of the present invention is partially cross-layered combined to be thermal conductive composing structure.

Structure characteristics of cross layer combination as shown in FIG. 8 are the following:

The thermal conducting surface of first thermal body (101) is partially combined with relay thermal conductor (102), and partially combined with interface thermal conductor (103);

The thermal conducting surface of relay thermal conductor (102) is partially combined with first thermal body (101), partially combined with thermal conductive interlayer (110), and partially combined with t interface thermal conductor (103);

The thermal conducting surface of thermal conductive interlayer (110) is partially combined with relay thermal conductor (102), and partially combined with interface thermal conductor (103);

The thermal conducting surface of interface thermal conductor (103) is partially combined with first thermal body (101), partially combined with relay thermal conductor (102), partially combined with thermal conductive interlayer (110), and partially coupled with second thermal body (104);

The first thermal body (101) can be the heat source or heat absorbing body;

The second thermal body (104) can be the heat source or heat absorbing body.

FIG. 9 is the sixth schematic view showing that the multi-layered structure of the present invention is partially cross-layered combined to be thermal conductive composing structure.

Structure characteristics of cross layer combination as shown in FIG. 9 are the following:

The thermal conducting surface of first thermal body (101) is partially combined with relay thermal conductor (102), and partially combined with interface thermal conductor (103);

The thermal conducting surface of relay thermal conductor (102) is partially combined with first thermal body (101), partially combined with thermal conductive interlayer (110), and partially combined with interface thermal conductor (103);

The thermal conducting surface of thermal conductive interlayer (110) is partially combined with first thermal body (101), partially combined with relay thermal conductor (102), and partially combined with interface thermal conductor (103);

The thermal conducting surface of interface thermal conductor (103) is partially combined with first thermal body (101), partially combined with relay thermal conductor (102), partially combined with thermal conductive interlayer (110), and partially coupled with second thermal body (104);

The conductive area, thickness and thermal characteristics of thermal conductive material of each cross-layer combined surface and original multi-layer combined surface can be selected according to thermal flow distribution of temperature difference and application conditions;

The first thermal body (101) can be the heat source or heat absorbing body;

The second thermal body (104) can be the heat source or heat absorbing body.

In case of more than one layer of thermal conductive interlayer (110), the principle of cross-layer combination for the applications shown in FIGS. 3˜9 can be similarly deduced.

For the thermal conduction principle and device for intercrossed structure having different thermal characteristics of the present invention, applications of the layer by layer overlapping multi-layer structure or the applications of multi-layer structure being partially cross-layer combined can be made to various geometric shapes according to conditions of usage.

For the thermal conduction principle and device for intercrossed structure having different thermal characteristics of the present invention, the thermal conducting or heat dissipating assembled structure can be constituted by first thermal body (101), relay thermal conductor (102), interface thermal conductor (103), second thermal body (104), and/or the thermal conductive interlayer (110) being optionally installed as needed utilizing thermal conductive material in gradually layered structure arranged according to the required thermal conductive characteristics of the multi-layered structure, wherein if all or partially neighboring thermal conductors constituting the thermal conducting or heat dissipating assembled structure are solid state material, and each structure layer is in prestressed-clamping type combined structure to reduce volume and has a prestressed clearance (500) to produce clamping or outwardly expanding prestressing force to ensure good thermal conducting contact and to avoid loosening or deformation of the multi-layer structure material due to different coefficients of thermal expansion to result in poor thermal conducting surface unfavorable for thermal conduction, then the combining methods between the two neighboring thermal conductors include one or more than one of the following:

1. Lockingly combined by external screws and nuts; or

2. Mutually threadly combined by spiral post and spiral hole structure; or

3. Mutually threadly combined by spiral post and spiral hole structure, and is installed with prestressed clearance (500) for prestressed-clamping combination; or

4. Rivetingly fastened; or

5. Pressingly combined; or

6. Clampingly fastened; or

7. Adhesively combined; or

8. Weldingly combined; or

9. Frictionally fusionly combined; or

10. Neighboring thermal conductors are castedly combined; or

11. Neighboring thermal conductors are electroplatedly combined; or

12. The thermal conducting structure between neighboring thermal conductors and another thermal conductor are fixedly attachingly combined or translationally attachingly combined; or

13. Neighboring thermal conductors are tightly touchingly combined by gravity; or

14. Neighboring thermal conductors are tightly touchingly combined by attraction of magnet device; or

15. Neighboring thermal conductors are combined as an enclosed structure.

For the thermal conduction principle and device for intercrossed structure having different thermal characteristics of the present invention, one or more than one auxiliary thermal conducting method can be optionally selected to be installed between first thermal body (101) and relay thermal conductor (102); or between relay thermal conductor (102) and interface thermal conductor (103); or between interface thermal conductor (103) and second thermal body (104); or between relay thermal conductor (102) and thermal conductive interlayer (110) if thermal conductive inter-layer (110) installed, or between thermal conductive interlayer (110) and thermal conductive interlayer (110) if multiple layered thermal conductive interlayer (110) is installed; or between thermal conductive interlayer (110) and interface thermal conductor (103), including:
1. To be installed with electrically insulated heat conductive piece; or
2. To be coated with thermally conductive grease; or
3. To be installed with electrically insulated thermal conductive piece and coated with thermally conductive grease.

The thermal conduction principle and device for intercrossed structure having different thermal characteristics of the present invention can be applied for various heat absorbing or dissipating, or cooling thermal conductive application devices, such as heat absorption and dissipation of various machine casings, heat pipe structures, structure casings, semiconductor components, ventilation devices, or the heat absorption, heat dissipation or thermal energy conduction of information, audio or image devices, or heat dissipation of various lamp or LED devices, or the heat absorption or dissipation or thermal energy conduction of air conditioning devices, electrical machines or engine, or heat dissipation of thermal energy conduction from frictional heat loss of the mechanical devices, or heat dissipation or thermal energy conduction of electric heater or other electric heating home appliances or cooking devices, or heat absorption or thermal energy conduction of flame heating stoves or cooking devices, or heat absorption, heat dissipation or thermal energy conduction of earth layer or water thermal energy, plant or housing building or building material or building structure devices, heat absorbing or dissipation of water tower, or heat absorption, heat dissipation or thermal energy conduction of batteries or fuel cells, etc;

Or it can be applied for thermal energy conduction in home appliances, industrial products, electronic products, electrical machines or mechanical devices, power generation equipments, buildings, air conditioning devices, industrial equipments or industrial manufacturing process.

1. A thermal conduction principle and device for intercrossed structure having different thermal characteristics, wherein the thermal conducting structure of the particular intercrossed overlapping layer construction is made of materials with different thermal conducting characteristics, wherein the relay thermal conductor of the thermal conduction principle and device for intercrossed structure having different thermal characteristics of the present invention being made of material with better thermal conductivity coefficient is thermal conductively coupled with the heating or cooling first thermal body at one end or surface thereof, and is coupled with interface thermal conductor at the other end or surface thereof, wherein the relay thermal conductor directly perform thermal conduction with the second thermal body at another part thereof, wherein said interface thermal conductor having the thermal conducting characteristics with all or at least one of the 1) higher specific heat capacity relative to relay thermal conductor, or 2) a better thermal conductivity coefficient to second thermal body relative to relay thermal conductor, or 3) a better thermal emissivity to second thermal body relative to relay thermal conductor being good is used as the thermal conducting carrier between the relay thermal conductor and the second thermal body; and is favorable for thermal energy conduction by the particular intercrossed overlapping layer construction having different thermal characteristics when there is temperature difference between the first thermal body and the second thermal body.

2. A thermal conduction principle and device for intercrossed structure having different thermal characteristics as claimed in claim 1, wherein the structure characteristics of cross layer combination are the following:
The thermal conducting surface of first thermal body (101) is partially combined with relay thermal conductor (102), and partially combined with interface thermal conductor (103);
The thermal conducting surface of relay thermal conductor (102) is partially combined with first thermal body (101), and partially combined with interface thermal conductor (103);
The thermal conducting surface of interface thermal conductor (103) is partially coupled with second thermal body (104);
The conductive area, thickness and thermal characteristics of thermal conductive material of each cross-layer combined surface and original multi-layer combined surface can be selected according to thermal flow distribution of temperature difference and application conditions;
The first thermal body (101) can be the heat source or heat absorbing body;
The second thermal body (104) can be the heat source or heat absorbing body.

3. A thermal conduction principle and device for intercrossed structure having different thermal characteristics as claimed in claim 1, wherein the structure characteristics of cross layer combination are the following:
The thermal conducting surface of first thermal body (101) is partially combined with relay thermal conductor (102), and partially combined with thermal conductive interlayer (110);
The thermal conducting surface of relay thermal conductor (102) is partially combined with first thermal body (101), and partially combined with thermal conductive interlayer (110);
The thermal conducting surface of thermal conductive interlayer (110) is partially combined with interface thermal conductor (103), partially combined with relay thermal conductor (102), and partially combined with first thermal body (101);
The thermal conducting surface of interface thermal conductor (103) is partially combined with thermal conductive interlayer (110), and partially coupled with second thermal body (104);
The conductive area, thickness and thermal characteristics of thermal conductive material of each cross-layer combined surface and original multi-layer combined surface can be selected according to thermal flow distribution of temperature difference and application conditions;
The first thermal body (101) can be the heat source or heat absorbing body;
The second thermal body (104) can be the heat source or heat absorbing body.

4. A thermal conduction principle and device for intercrossed structure having different thermal characteristics as claimed in claim 1, wherein the structure characteristics of cross layer combination are the following:
The thermal conducting surface of first thermal body (101) is combined with relay thermal conductor (102);
The thermal conducting surface of relay thermal conductor (102) is partially combined with first thermal body (101), partially combined with thermal conductive interlayer (110), and partially combined with interface thermal conductor (103);
The thermal conducting surface of thermal conductive interlayer (110) is partially combined with interface thermal conductor (103), and partially combined with relay thermal conductor (102);
The thermal conducting surface of interface thermal conductor (103) is partially combined with thermal conductive interlayer (110), partially combined with relay thermal conductor (102), and partially coupled with second thermal body (104);
The conductive area, thickness and thermal characteristics of thermal conductive material of each cross-layer combined surface and original multi-layer combined surface can be selected according to thermal flow distribution of temperature difference and application conditions;
The first thermal body (101) can be the heat source or heat absorbing body;
The second thermal body (104) can be the heat source or heat absorbing body.

5. A thermal conduction principle and device for intercrossed structure having different thermal characteristics as claimed in claim 1, wherein the structure characteristics of cross layer combination are the following:
The thermal conducting surface of first thermal body (101) is partially combined with relay thermal conductor (102), partially combined with thermal conductive interlayer (110), and partially combined with interface thermal conductor (103);
The thermal conducting surface of relay thermal conductor (102) is partially combined with first thermal body (101), and partially combined with thermal conductive interlayer (110);
The thermal conducting surface of thermal conductive interlayer (110) is partially combined with interface thermal conductor (103), partially combined with relay thermal conductor (102), and partially combined with first thermal body (101);
The thermal conducting surface of interface thermal conductor (103) is partially combined with thermal conductive interlayer (110), partially combined with first thermal body (101), and partially coupled with second thermal body (104);
The conductive area, thickness and thermal characteristics of thermal conductive material of each cross-layer combined surface and original multi-layer combined surface can be selected according to thermal flow distribution of temperature difference and application conditions;
The first thermal body (101) can be the heat source or heat absorbing body;
The second thermal body (104) can be the heat source or heat absorbing body.

6. A thermal conduction principle and device for intercrossed structure having different thermal characteristics as claimed in claim 1, wherein the structure characteristics of cross layer combination are the following:
The thermal conducting surface of first thermal body (101) is partially combined with relay thermal conductor (102), partially combined with thermal conductive interlayer (110), and partially combined with interface thermal conductor (103);
The thermal conducting surface of relay thermal conductor (102) is partially combined with first thermal body (101), partially combined with thermal conductive interlayer (110), and partially combined with interface thermal conductor (103);
The thermal conducting surface of thermal conductive interlayer (110) is partially combined with first thermal body (101), partially combined with relay thermal conductor (102), and partially combined with interface thermal conductor (103);
The thermal conducting surface of interface thermal conductor (103) is partially combined with first thermal body (101), partially combined with relay thermal conductor (102), partially combined with thermal conductive interlayer (110), and partially coupled with second thermal body (104);
The conductive area, thickness and thermal characteristics of thermal conductive material of each cross-layer combined surface and original multi-layer combined surface can be selected according to thermal flow distribution of temperature difference and application conditions;
The first thermal body (101) can be the heat source or heat absorbing body;
The second thermal body (104) can be the heat source or heat absorbing body.

7. A thermal conduction principle and device for intercrossed structure having different thermal characteristics as claimed in claim 1, wherein the structure characteristics of cross layer combination are the following:
The thermal conducting surface of first thermal body (101) is partially combined with relay thermal conductor (102), and partially combined with interface thermal conductor (103);
The thermal conducting surface of relay thermal conductor (102) is partially combined with first thermal body (101), partially combined with thermal conductive interlayer (110), and partially combined with t interface thermal conductor (103);
The thermal conducting surface of thermal conductive interlayer (110) is partially combined with relay thermal conductor (102), and partially combined with interface thermal conductor (103);
The thermal conducting surface of interface thermal conductor (103) is partially combined with first thermal body (101), partially combined with relay thermal conductor (102), partially combined with thermal conductive interlayer (110), and partially coupled with second thermal body (104);
The first thermal body (101) can be the heat source or heat absorbing body;
The second thermal body (104) can be the heat source or heat absorbing body.

8. A thermal conduction principle and device for intercrossed structure having different thermal characteristics as claimed in claim 1, wherein the structure characteristics of cross layer combination are the following:
The thermal conducting surface of first thermal body (101) is partially combined with relay thermal conductor (102), and partially combined with interface thermal conductor (103);
The thermal conducting surface of relay thermal conductor (102) is partially combined with first thermal body (101), partially combined with thermal conductive interlayer (110), and partially combined with interface thermal conductor (103);
The thermal conducting surface of thermal conductive interlayer (110) is partially combined with first thermal body (101), partially combined with relay thermal conductor (102), and partially combined with interface thermal conductor (103);
The thermal conducting surface of interface thermal conductor (103) is partially combined with first thermal body (101), partially combined with relay thermal conductor (102), partially combined with thermal conductive interlayer (110), and partially coupled with second thermal body (104);
The conductive area, thickness and thermal characteristics of thermal conductive material of each cross-layer combined surface and original multi-layer combined surface can be selected according to thermal flow distribution of temperature difference and application conditions;
The first thermal body (101) can be the heat source or heat absorbing body;
The second thermal body (104) can be the heat source or heat absorbing body.

9. A thermal conduction principle and device for intercrossed structure having different thermal characteristics as claimed in claims 2, 3, 4, 5, 6, 7 or 8, wherein in case of more than one layer of thermal conductive interlayer (110), the principle of cross-layer combination can be similarly deduced.

10. A thermal conduction principle and device for intercrossed structure having different thermal characteristics as claimed in claim 1 can be made to various geometric shapes according to conditions of usage.

11. A thermal conduction principle and device for intercrossed structure having different thermal characteristics, wherein the thermal conducting or heat dissipating assembled structure can be constituted by first thermal body (101), relay thermal conductor (102), interface thermal conductor (103), second thermal body (104), and/or the thermal conductive interlayer (110) being optionally installed as needed utilizing thermal conductive material in gradually layered structure arranged according to the required thermal conductive characteristics of the multi-layered structure, wherein if all or partially neighboring thermal conductors constituting the thermal conducting or heat dissipating assembled structure are solid state material, and each structure layer is in prestressed-clamping type combined structure to reduce volume and has a prestressed clearance (500) to produce clamping or outwardly expanding prestressing force to ensure good thermal conducting contact and to avoid loosening or deformation of the multi-layer structure material due to different coefficients of thermal expansion to result in poor thermal conducting surface unfavorable for thermal conduction, then the combining methods between the two neighboring thermal conductors include one or more than one of the following:
1) Lockingly combined by external screws and nuts; or
2) Mutually threadly combined by spiral post and spiral hole structure; or
3) Mutually threadly combined by spiral post and spiral hole structure, and is installed with prestressed clearance (500) for prestressed-clamping combination; or
4) Rivetingly fastened; or
5) Pressingly combined; or
6) Clampingly fastened; or
7) Adhesively combined; or
8) Weldingly combined; or
9) Frictionally fusionly combined; or
10) Neighboring thermal conductors are castedly combined; or
11) Neighboring thermal conductors are electroplatedly combined; or
12) The thermal conducting structure between neighboring thermal conductors and another thermal conductor are fixedly attachingly combined or translationally attachingly combined; or
13) Neighboring thermal conductors are tightly touchingly combined by gravity; or
14) Neighboring thermal conductors are tightly touchingly combined by attraction of magnet device; or
15) Neighboring thermal conductors are combined as an enclosed structure.

12. A thermal conduction principle and device for intercrossed structure having different thermal characteristics as claimed in claim 1, wherein one or more than one auxiliary thermal conducting method can be optionally selected to be installed between first thermal body (101) and relay thermal conductor (102); or between relay thermal conductor (102) and interface thermal conductor (103); or between interface thermal conductor (103) and second thermal body (104); or between relay thermal conductor (102) and thermal conductive interlayer (110) if thermal conductive inter-layer (110) installed, or between thermal conductive interlayer (110) and thermal conductive interlayer (110) if multiple layered thermal conductive interlayer (110) is installed; or between thermal conductive interlayer (110) and interface thermal conductor (103), including:
1) To be installed with electrically insulated heat conductive piece; or
2) To be coated with thermally conductive grease; or
3) To be installed with electrically insulated thermal conductive piece and coated with thermally conductive grease.

13. A thermal conduction principle and device for intercrossed structure having different thermal characteristics as claimed in claim 1, wherein it can be applied for various heat absorbing or dissipating, or cooling thermal conductive application devices, such as heat absorption and dissipation of various machine casings, heat pipe structures, structure casings, semiconductor components, ventilation devices, or the heat absorption, heat dissipation or thermal energy conduction of information, audio or image devices, or heat dissipation of various lamp or LED devices, or the heat absorption or dissipation or thermal energy conduction of air conditioning devices, electrical machines or engine, or heat dissipation of thermal energy conduction from frictional heat loss of the mechanical devices, or heat dissipation or thermal energy conduction of electric heater or other electric heating home appliances or cooking devices, or heat absorption or thermal energy conduction of flame heating stoves or cooking devices, or heat absorption, heat dissipation or thermal energy conduction of earth layer or water thermal energy, plant or housing building or building material or building structure devices, heat absorbing or dissipation of water tower, or heat absorption, heat dissipation or thermal energy conduction of batteries or fuel cells, etc;
Or it can be applied for thermal energy conduction in home appliances, industrial products, electronic products, electrical machines or mechanical devices, power generation equipments, buildings, air conditioning devices, industrial equipments or industrial manufacturing process.
